(19) United States
(12) Patent Application Publication
(10) Pub. No.: US 2026/0124685 A1
(43) Pub. Date: May 7, 2026

(54) DRILL AND TAP GUIDE

(71) Applicant: Hui Chuan Liao, Oakland, CA (US)

(72) Inventors: Hui Chuan LIAO, Oakland, CA (US); Chun-Ti WANG, Taichung City (TW); Meng-Fu JI, Taichung City (TW); Chi-Cheung FOO, Taichung City (TW)

(21) Appl. No.: 18/939,958

(22) Filed: Nov. 7, 2024

(51) Int. Cl. B23B 47/28; B23G 1/48

(52) U.S. Cl. CPC B23B 47/281; B23G 1/48; B23B 2247/18

(57) ABSTRACT

A drill and tap guide includes an elongated body having a top surface, a bottom surface, a first side, a second side, a first end, and a second end, the elongated body defining a longitudinal axis which intersects the first and second ends, and a plurality of guide holes extending perpendicularly through the elongated body between the top surface and the bottom surface, at least one of the guide holes including a central axis which intersects the longitudinal axis of the elongated body. The elongated body also includes a positioning notch formed in the bottom surface of the elongated body, where the positioning notch including two edges on opposite sides of the positing notch, the edges forming an angle α with the bottom surface, and a recess between the edges, the recess being a portion of the positioning notch which is a farthest distance away from the bottom surface.

### BACKGROUND

The present invention relates to a device used to aid the machining of a workpiece, and more particularly, to a drill and tap guide used to drill and tap straight holes in workpieces, including planar surfaces, nonplanar surfaces, lateral surfaces or edges of workpieces.

Drill and tap guides have long been used in the art of drilling and tapping holes in a workpiece. Traditional drill and tap guides include a body having a plurality of guide holes of varying diameters. In use, the guide hole having the desired diameter is positioned by hand over the place on the workpiece where the hole is to be drilled or the tap made. A user then holds the drill and tap guide in place with one hand while drilling the hole using a hand powered drill with the other hand. It is preferable to produce straight and accurately located holes in workpieces, particularly, when later joining such parts to form a structural assembly.

Traditional drill and tap guides, however, have presented concerns relating to alignment and application. For example, conventional drill and tap guides are often difficult to properly align with the desired target point on the workpiece. Further, with respect to nonplanar configurations, conventional guides typically offer one-size-fits-all solutions that limit their application. Of yet further concern, conventional drill and tap guides typically offer little room for the removal of extrusions or chips produced during drilling, which may compromise the quality of the hole.

As such, there remains a need for an improved drill and tap guide that facilitates accurate manual alignment of a guide hole and targeted point on the workpiece, increases the useful applications of the drill and tap guide, and facilitates removal of extrusions or chips during drilling.

### SUMMARY

The above-listed need is met or exceeded by the present drill and tap guide. In particular, the present drill and tap guide includes an elongated body with first and second sides which are curved in a concave manner for improved ergonomics, and positioning slits along the first and second sides which align with central axes of drill and tap guide holes of the drill and tap guide. The positioning slits facilitate proper alignment with a workpiece. As such, the present drill and tap guide is useful to effect more precise and facile manual machining of straight through-holes and borings.

Further, the present drill and tap guide includes a positioning notch along a bottom edge of the drill and tap guide which increases the variety of applications for which a single guide is optionally used. For example, the present drill and tap guide facilitates use with a greater number of tubular and square workpiece configurations, in comparison to prior art guides. The positioning notch is further useful to produce straight borings within the sides or ends of panels, such as hard wood flooring. Additionally, the various embodiments of the present drill and tap guide include differing geometries, each of which provide unique benefits. In one embodiment, the positioning notch includes step shaped profiles which are recessed within edges of the positioning notch, where the step shaped profiles include vertical and horizontal walls which form a right triangle.

Another embodiment includes a positioning notch with undulation profiles including concave and convex curves which are interspaced. Preferably, straight line segments connect the concave and convex curves. In this embodiment, circular or tubular workpieces are preferably accommodated within the concave curves, and the horizontally oriented straight line segments preferably accommodate flat workpieces.

In a further embodiment, the positioning notch includes zig zag profiles along each of the edges. The zig zag profiles preferably include opposing walls which form an obtuse angle, where the walls form tips which optionally contact angled work pieces.

Additionally, the present drill and tap guide preferably includes a cavity disposed below a top surface of the elongated body, such that the cavity is defined between the first and second sides, and the first and second ends. Preferably, the guide holes include cylindrical side walls which extend beyond the top surface and into the cavity. Further, the cavity preferably includes a plurality of projections which extend between the first and second sides and each of the cylindrical the cylindrical side walls. Each of the projections preferably includes a shape matching one of the two edges of the positioning notch and each of the projections is preferably aligned with the central axis of each of the guide holes.

The cavity and the presence of the projections within the cavity advantageously help facilitate the removal of extrusions or chips during drilling, which reduces repetitively unclamp and re-clamp the guide during a project. Specifically, the space provided within the cavity helps allow dust, chips, or extrusions formed by drilling or tapping to escape. With respect to tapping, the present drill and tap guide helps reduce the likelihood that the tap will be broken or have its integrity otherwise compromised.

More specifically, a drill and tap guide includes an elongated body having a top surface, a bottom surface, a first side, a second side, a first end, and a second end, the elongated body defining a longitudinal axis which intersects the first and second ends, and a plurality of guide holes extending perpendicularly through the elongated body between the top surface and the bottom surface, at least one of the guide holes including a central axis which intersects the longitudinal axis of the elongated body. The elongated body also includes a positioning notch formed in the bottom surface of the elongated body, where the positioning notch including two edges on opposite sides of the positing notch, the edges forming an angle α with the bottom surface, and a recess between the edges, the recess being a portion of the positioning notch which is a farthest distance away from the bottom surface.

In preferred embodiments, the recess is rectangular in shape, such that the recess includes an upper edge which is parallel to the bottom surface, the first and second sides are curved in a concave manner when viewed from the top surface, and the first and second ends are curved in a convex manner when viewed from the top surface. Preferably, the first and second ends include a position slit in line with the longitudinal axis of the elongated body, and the first and second sides include at least one position slit in line with the central axis of the at least one guide hole.

In another preferred embodiment, the elongated body includes a cavity disposed below the top surface and between the first and second sides, such that each of the plurality of guide holes include a cylindrical side wall which extends beyond the top surface into the cavity. Preferably, each of the cylindrical side walls extends into the cavity a distance less than a distance between the top surface and the bottom surface. Preferably still, the cavity includes a plurality of first projections between the first side and each of the cylindrical side walls, and the cavity includes second projections between the second side and each of the cylindrical side walls, such that each of the projections include a shape matching one of the two edges of the positioning notch and each of the projections is aligned with the central axis of the guide holes.

In yet another preferred embodiment, the positioning notch includes at least one step-shape profile along each of the edges. Preferably, the at least one step-shape profile includes a vertical wall and a horizontal wall which form a right triangle, the at least one step-shape profile is displaced from the bottom surface and is displaced from the recess along the edge, and the at least one step-shape profile is recessed within each of the edges.

In a further preferred embodiment, the positioning notch includes undulation profiles along each of the edges. Preferably, the undulation profiles include a plurality of convex curves interspaced between a plurality of convex curves along each of the edges, such that the plurality of convex curves and the plurality of concave curves are connected by straight line segments. Preferably still, the undulation profiles extend between the bottom surface and the recess along each of the edges.

In yet another preferred embodiment, the positioning notch includes zig zag profiles along each of the edges. Preferably, the zig zag profiles are displaced from the bottom surface and are displaced from the recess along each of the edges, and each of the zig zag profiles include opposing walls which form a tip, such that the walls of each of the zig zag profiles form an obtuse angle.

### BRIEF DESCRIPTION OF THE DRAWINGS

FIG. 1 is a top perspective view of a first embodiment of the present drill and tap guide which includes a positioning notch with step-shape profiles engaging a tubular workpiece;

FIG. 2 is a bottom perspective view of the drill and tap guide shown in FIG. 1;

FIG. 3 is a top plan view of the drill and tap guide shown in FIG. 1;

FIG. 4 is a side plan view of the drill and tap guide shown in FIG. 1;

FIG. 5 is a bottom plan view of the drill and tap guide shown in FIG. 1;

FIG. 6A is front plan view of the drill and tap guide shown in FIG. 1;

FIG. 6B is an enlarged view showing the step-shaped profiles of the positioning notch of the drill and tap guide shown in FIG. 6A;

FIG. 7 is a front plan view of the present drill and tap guide of FIG. 1 engaging a flat workpiece;

FIG. 8 is a front plan view of the present drill and tap guide of FIG. 1 engaging an angled workpiece;

FIG. 9 is a top perspective view of a second embodiment of the present drill and tap guide which includes a positioning notch with undulation profiles engaging a tubular workpiece;

FIG. 10A is front plan view of the drill and tap guide shown in FIG. 9;

FIG. 10B is an enlarged view showing the undulation profiles of the positioning notch of the drill and tap guide shown in FIG. 10A;

FIG. 11 is a top perspective view of a third embodiment of the present drill and tap guide which includes a positioning notch with zig zag profiles engaging a tubular workpiece;

FIG. 12A is front plan view of the drill and tap guide shown in FIG. 11; and

FIG. 12B is an enlarged view showing the zig zag profiles of the positioning notch of the drill and tap guide shown in FIG. 12A.

### DETAILED DESCRIPTION

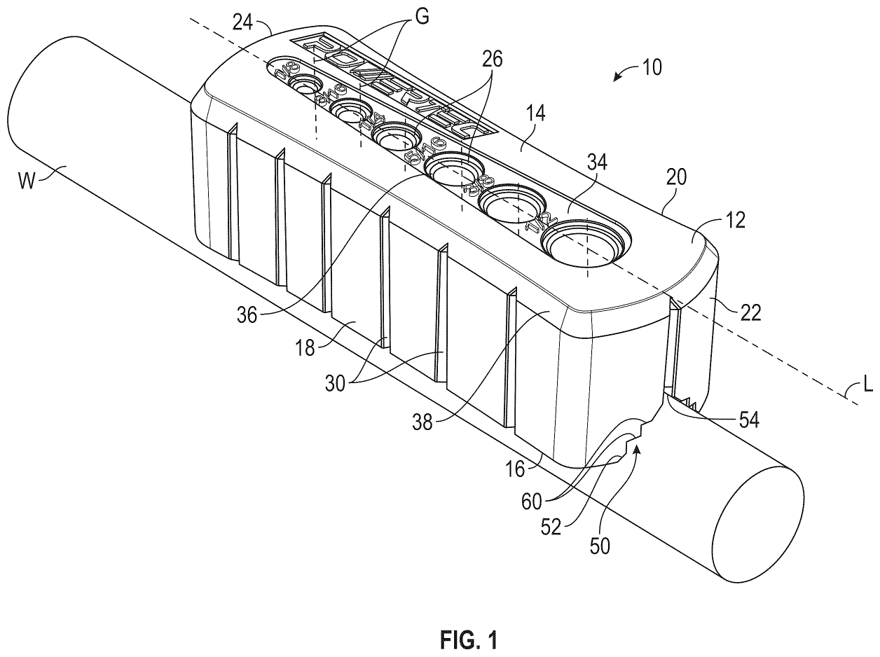

Referring now to FIGS. 1-5, in which the components are shown schematically and not to scale, a first embodiment of the drill and tap guide is generally designated 10 and includes an elongated body 12 having a top surface 14, a bottom surface 16, a first side 18, a second side 20, a first end 22 and a second end 24. The drill and tap guide 10 shown in FIG. 1 is disposed upon a workpiece W. While the workpiece W shown in FIG. 1 is a tubular workpiece, it is contemplated that other geometry workpieces are optionally processed with the drill and tap guide 10.

The elongated body 12 defines a longitudinal axis L (FIG. 1) and includes a plurality of standard diameter-sized guide holes 26 for receiving and entraining at least a portion of a tool (e.g., drill bit, tap and die set, etc.) (not shown). A notable standard for dimensioning of the guide holes 26 is ANSI, and the diameter size of the guide holes is optionally provided in metric or English units. Each guide hole 26 defines a central guide hole axis G (FIG. 1), such that the central guide hole axes are preferably disposed along the longitudinal axis L.

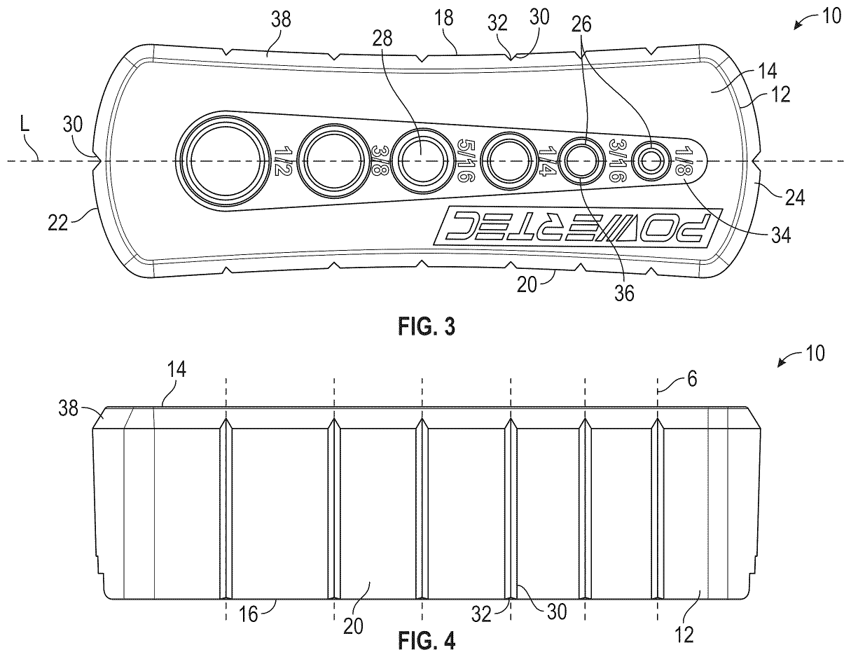

Preferably, as shown in FIG. 3, the first and second sides 18, 20 are curved in a concave manner, such that a width of the elongated body 12 is smallest at a center point 28 of the elongated body along the longitudinal axis L. In a preferred embodiment, the first and second ends 22, 24 are curved in a convex manner, such that a length of the elongated body 12 is greatest along the longitudinal axis L. Advantageously, the curved nature of the first and second sides 18, 20 helps improve the ergonomics of the drill and tap guide 10, by providing a more comfortable grip for a user of the drill and tap guide.

Referring now to FIGS. 1-4, the first and second sides 18, 20 preferably include a plurality of position slits 30 which align with the guide holes 26, such that an end 32 of each of the position slits points to the central guide hole axis G of the respective guide holes 26. In this way, the position slits 30 help improve alignment of the guide hole 26 with a desired target point on the workpiece W. In a preferred embodiment, the first and second ends 22, 24 also include a position slit 30 which is aligned with the longitudinal axis L. As illustrated in FIG. 3, the position slits 30 preferable have a triangular shape, with angled sides which meet at the end 32. However, other shapes are contemplated for the position slit 30 as is known in the art.

In an embodiment, the top surface 14 preferably includes a recessed surface 34 in which the guide holes 26 are located, and an edge 36 of the guide holes 26 is chamfered to improve alignment of a tool with the respective guide hole. Preferably, an outer periphery 38 of the top surface 14 is chamfered.

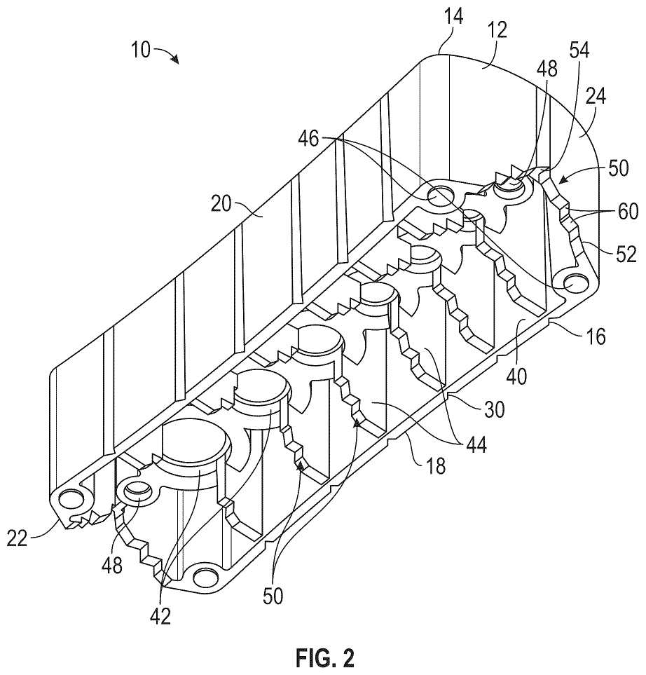

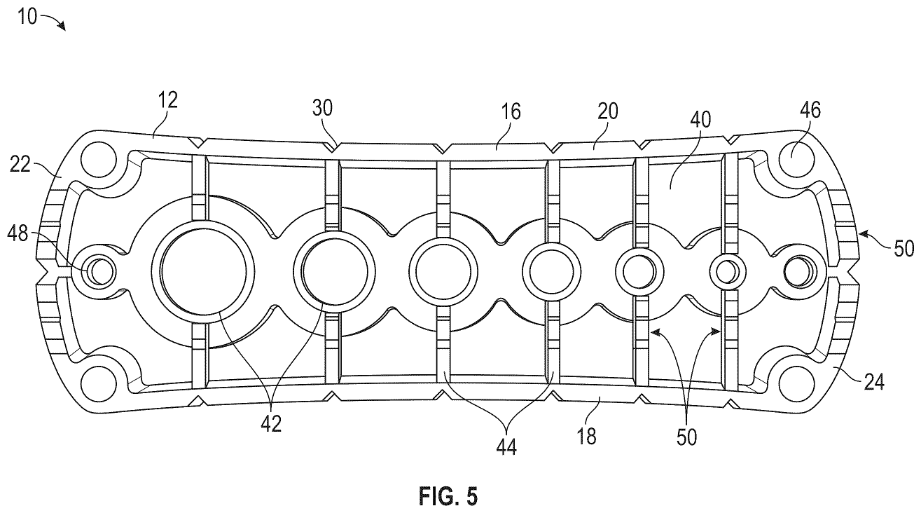

Referring now to FIGS. 2 and 5, the elongated body 12 includes a cavity 40 below the top surface 14, which is formed between the first and second sides 18, 20 and the first and second ends 22, 24. The bottom of the cavity 40 is formed by the bottom surface 16. Within the cavity 40, the guide holes 26 include cylindrical side walls 42 which extend into the cavity a distance less than the bottom surface 16. Preferably, the cavity 40 includes a plurality of projections 44 which connect the first and second sides 18, 20 and the cylindrical side walls 42. In an embodiment, the projections 44 extend from the underside of the top surface 14 a distance less than, or equal to, a length of the first and second sides 18, 20. Additionally, the bottom surface 16 preferably includes a plurality of feet 46 at corners of the elongated body 12. The feet 46 are made of a suitable resilient material, such as rubber, which provides sufficient traction to hold the drill and tap guide 10 stationary when in use.

In a preferred embodiment, the cavity 40 is substantially hollow, as the area inside the cavity preferably includes only the cylindrical side walls 42 of the guide holes 26, the projections 44, and tubular protrusions 48 which extend from the bottom side of the top surface 14. This configuration of the cavity 40 is advantageous for injection molding or additive manufacturing, as it reduces the overall thickness the walls of the elongated body 12. Additionally, the hollow nature of the cavity 40 provides space so that wood chips and saw dust created by drilling or tapping a workpiece W using the drill and tap guide 10 will not get trapped against the workpiece. Rather, the wood chips and saw dust created during drilling or tapping the desired target point on the workpiece are allowed to enter the hollow space within the cavity 40, helping improve the quality of the drilled or tapped hole.

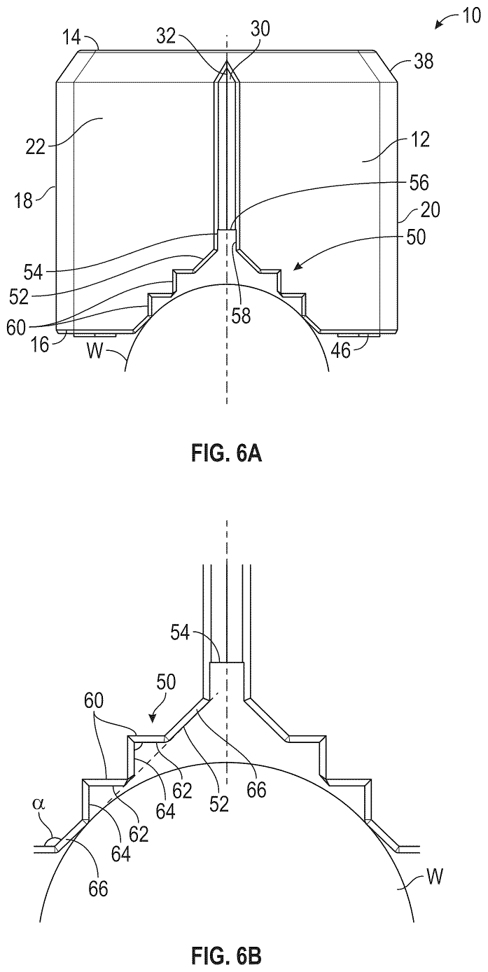

Referring to FIGS. 1, 6A, and 6B, the elongated body 12 preferably includes a positioning notch 50 on the bottom surface 16 which is configured to, among other things, promote alignment and more stable engagement with angular and curvilinear (e.g., tubular) workpieces. The positioning notch 50 runs along and is centered about the longitudinal axis L. In an embodiment, the positioning notch 50 includes a mirrored pair of edges 52 on opposite sides of the positioning notch. The edges 52 connect with and form an angle α with the bottom surface 16, where the angle α is preferably 135 degrees.

At a point opposite to where the edges 52 meet the bottom surface 16, the edges connect to a recess 54 within the positioning notch 50. Advantageously, the recess 54 is rectangular in shape, and includes a top face 56 which is parallel to the top surface 14 and lateral walls 58 which extend perpendicularly from the top face 56, and which connect the top face and the edges 52. In a preferred embodiment, the recess 54 is square such that a length of the top face 56 is the same as a length of the lateral walls 58. Alternatively, it is contemplated that the top face 56 optionally has a U-shaped cross-section, a V-shaped cross-section, or a semi-circular cross-section.

Referring now to FIGS. 6A and 6B, the edges 52 of the positioning notch 50 preferably include at least one step-shaped profile 60, which takes the form of a triangular cutout. Preferably, the at least one step-shaped profile 60 takes the form of a right triangle, which includes a horizontal wall 62 and a vertical wall 64. While FIGS. 6A and 6B shows two step step-shaped profiles 60, it is understood that greater or fewer step-shaped profiles 60 are optionally included on each edge 52. In a preferred embodiment, the step shaped profiles 60 are recessed within the edges 52 of the positioning notch 50. Further, the step shaped profiles 60 are preferably located on the edges 52, at a location displaced from the bottom surface 16 and the recess 54, such that there are spaces 66 between the bottom surface and the step shaped profiles, as well as between the recess and the step shaped profiles.

The positioning notch 50, and the recess 54 are laterally centered on the elongated body, such that the edges 52 work to center the workpiece W with respect to the drill guides 26. Additionally, the recess 54, in conjunction with edges 52, and the step-shaped profiles 60, allow the drill and tap guide 10 to accommodate a multitude of different workpiece shapes and geometries.

While FIGS. 1, 6A, and 6B illustrate the drill and tap guide 10 disposed upon a tubular workpiece W which has a diameter less than the width of the elongated body 12, it is appreciated that the drill and tap guide is optionally used on a workpiece having a diameter greater than the width of the elongated body. Additionally, when the tubular workpiece W has a diameter larger than the length of the top surface of the recess 54, the tubular workpiece is placed between corresponding edges 52 of the positioning notch. Thus, the edges 52 are positioned such that the drill and tap guide 10 is caused to straddle the central axis of the selected guide hole 26, and the guide hole is perpendicular to the targeted point on the tubular workpiece W. The drill and tap guide 10 is optionally used to guide a drill bit through the wall of, or entirely through, the tubular workpiece W, so as to form a perpendicular hole.

Referring now to FIGS. 2 and 5, the projections 42 preferably include the edges 52 and recess 54 of the profile notch 50. In this way, the workpiece is supported by each of the projections 42 while the drill and tap guide 10 is being pressed against the workpiece W. Additionally, the projections 42 allow the drill and tap guide 10 to be used on a workpiece W whose length is less than the length of the elongated body 12 in the longitudinal direction.

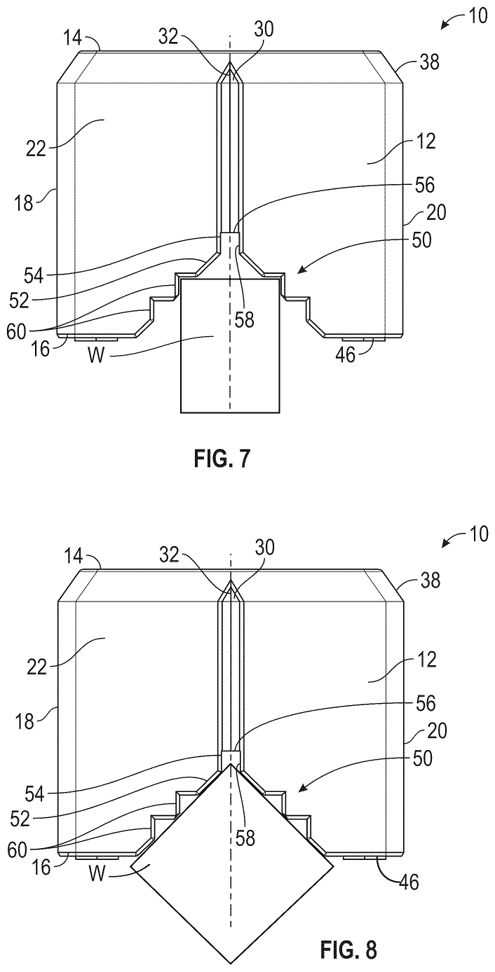

Referring now to FIG. 7, the drill and tap guide 10 is optionally used on flat workpieces W that have a width less than the width of the elongated body 12. For example, with flat workpieces W with a width greater than the length of the top face 56, but less than or equal to a distance between corresponding vertical walls 66 of respective triangular cutouts within the step-shaped profile 60 on opposing edges 52 of the positioning notch 50, the workpiece is placed within a space between the vertical walls. This helps improve the accuracy of the holes created with the aid of the drill and tap guide 10, since the workpiece is held more securely by aid of the step-shaped profiles 60.

Referring to FIG. 8, the positioning notch 50 optionally is used for workpieces W with nonplanar engaging surfaces. For example, an angular workpiece W, such as an angle iron, presents a 90-degree angle where at least one through-hole is to be formed. In these situations, the drill and tap guide 10 is preferably positioned by placing the edge of the workpiece W within the positioning notch 50, and more particularly, within the recess 54.

Moreover, the drill and tap guide 10 is optionally used for drilling or tapping a through-hole into a workpiece having a generally flat surface greater than the width of the elongated body 12. In such a case, the drill and tap guide 10 is positioned so that the feet 46 on the bottom surface 16 contact the surface of the workpiece W into which the through-hole or boring is to be drilled or tapped. As a result, when the drill and tap guide 10 rests upon the workpiece W, the guide holes 26 are perpendicular to the surface of the workpiece W. The drill and tap guide 10 is then positioned so that the applicable guide hole 26 of the desired diameter is centered on the position where the hole is to be machined (i.e., the targeted point) via the alignment provisions described above. By pressing the drill and tap guide 10 against the workpiece W with one hand or a clamp (not shown), the drill and tap guide is secured in place. The operator is then able to use the other hand to drill or tap the workpiece W.

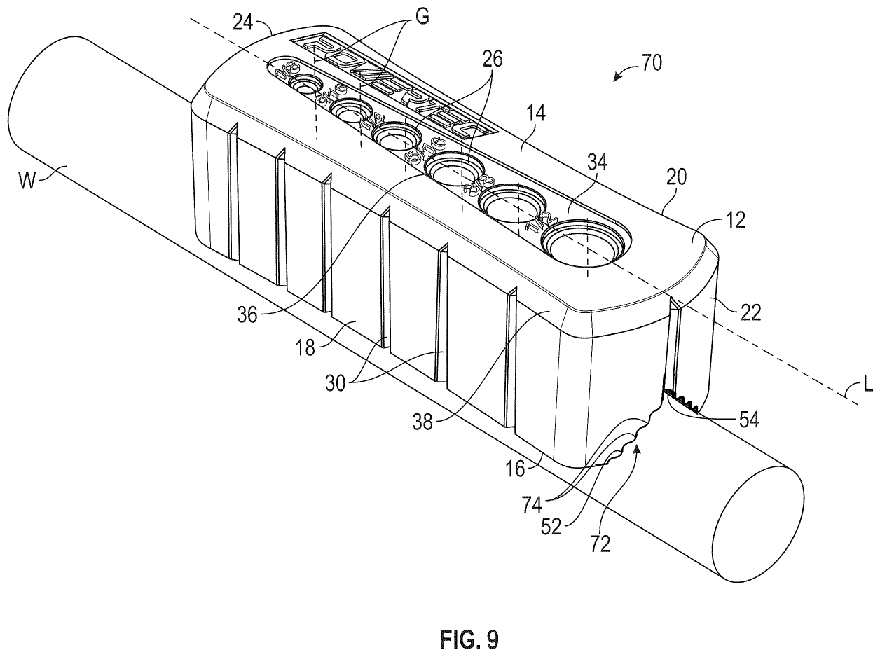

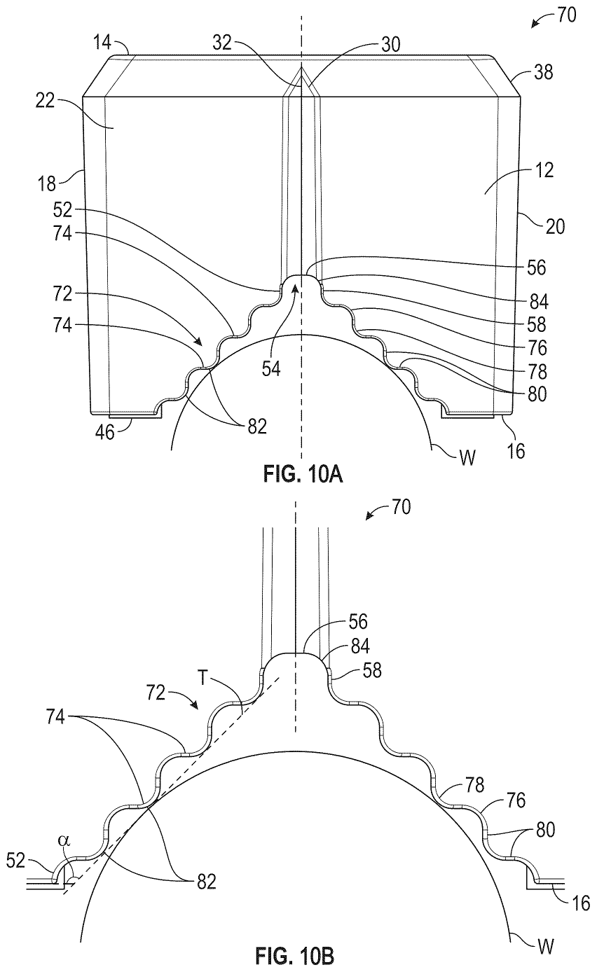

Referring now to FIGS. 9, 10A, and 10B, a second embodiment of the drill and tap guide is generally designated 70. Components shared with the drill and tap guide 10 are designated with identical reference numbers. The drill and tap guide 70 includes a positioning notch 72 with undulation profiles 74 along each of the edges 52. The undulation profiles preferably include a plurality of concave curves 76 and a plurality of convex curves 78 which are interspaced. In a preferred embodiment, the concave and convex curves 76, 78 have a semicircular shape with a radius R of approximately 0.049 inches (approximately 1.25 mm). Additionally, the plurality of concave and convex curves 76, 78 are preferably connected by straight line segments 80. In a preferred embodiment, the undulation profiles 74 extend the entire length of the edge 52 between the bottom surface 16 and the recess 54. Additionally, apexes 82 of the convex curves 76 are preferably aligned along a line T which forms the angle α with the bottom surface 16. Preferably, interfaces 84 between the top face 56 and the lateral walls 58 are rounded.

The line T is preferably formed at an approximately 45-degree angle with the central guide hole axes G, and preferably the lines T on each side of the positioning notch 72 form an angle of approximately 90 degrees.

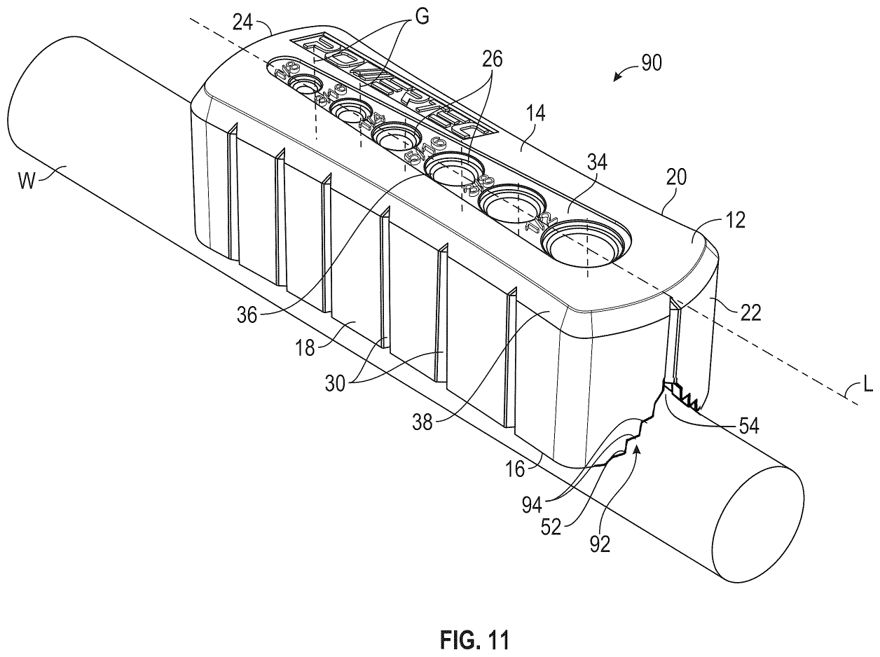

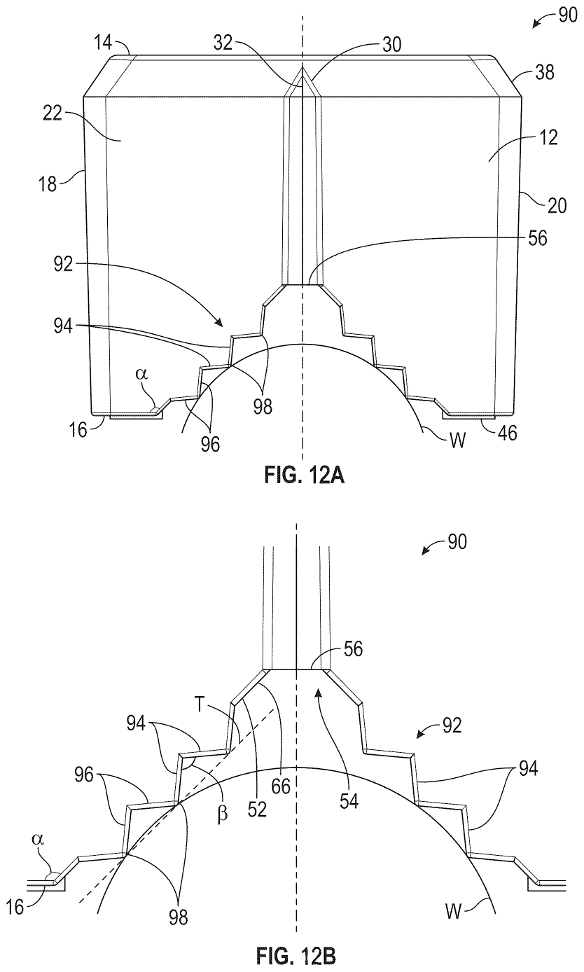

Referring now to FIGS. 11, 12A, and 12B, a third embodiment of the drill and tap guide is generally designated 90. Components shared with the drill and tap guide 10 are designated with identical reference numbers. The drill and tap guide 90 includes a positioning notch 92 with zig zag profiles 94 along each of the edges 52. As with the step shaped profiles 60, the zig zag profiles 94 are preferably located on the edges 52, at a location displaced from the bottom surface 16 and the recess 54, such that the spaces 66 are included between the bottom surface and the zig zag profiles, as well as between the recess and the zig zag profiles.

Each zig zag profile 94 preferably includes opposing walls 96 which form a tip 98 that optionally engages a tubular or angled workpiece W. In a preferred embodiment, the opposing walls 96 form an angle β which is obtuse. The angle β is preferably approximately 100 degrees. Additionally, the tips 98 of the zig zag profiles 94 are preferably aligned along a line T which is parallel to the edges 52, such that the zig zap profiles extend beyond the edges. The line T is preferably formed at an approximately 45-degree angle with the central guide hole axes G, and preferably the lines T on each side of the positioning notch 92 form an angle of approximately 90 degrees.

In a preferred embodiment, the recess 54 excludes the lateral walls 58, and the edge 52 connects directly to the top wall 56.

While a particular embodiment of the present drill and tap guide has been described herein, it will be appreciated by those skilled in the art that changes and modifications may be made thereto without departing from the invention in its broader aspects and as set forth in the following claims.

1. A drill and tap guide, comprising:
an elongated body having a top surface, a bottom surface, a first side, a second side, a first end, and a second end, said elongated body defining a longitudinal axis which intersects said first and second ends;
a plurality of guide holes extending perpendicularly through said elongated body between said top surface and said bottom surface, at least one of said guide holes including a central axis which intersects said longitudinal axis of said elongated body; and
a positioning notch formed in said bottom surface of said elongated body, said positioning notch including:
two edges on opposite sides of said positing notch, said edges forming an angle α with said bottom surface; and
a recess between said edges, said recess being a portion of said positioning notch which is a farthest distance away from said bottom surface.

2. The drill and tap guide of claim 1, wherein said recess is rectangular in shape, and wherein said recess includes a top face which is parallel to said bottom surface.

3. The drill and tap guide of claim 1, wherein said first and second sides are curved in a concave manner when viewed from said top surface.

4. The drill and tap guide of claim 1, wherein said first and second ends are curved in a convex manner when viewed from said top surface.

5. The drill and tap guide of claim 1, wherein said first and second ends include a position slit in line with said longitudinal axis of said elongated body.

6. The drill and tap guide of claim 1, wherein said first and second sides include at least one position slit in line with said central axis of said at least one guide hole.

7. The drill and tap guide of claim 1, wherein said elongated body includes a cavity disposed below said top surface and between said first and second sides, and wherein each of said plurality of guide holes include a cylindrical side wall which extends beyond said top surface into said cavity.

8. The drill and tap guide of claim 7, wherein each said cylindrical side wall extends into said cavity a distance less than a distance between said top surface and said bottom surface.

9. The drill and tap guide of claim 7, wherein said cavity includes a plurality of first projections between said first side and each said cylindrical side wall, and wherein said cavity includes second projections between said second side and each said cylindrical side wall, wherein each said projection includes a shape matching one of said two edges of said positioning notch and wherein each said projection is aligned with said central axis of said guide holes.

10. The drill and tap guide of claim 1, wherein said positioning notch further includes at least one step-shape profile along each said edge.

11. The drill and tap guide of claim 10, wherein said at least one step-shape profile includes a vertical wall and a horizontal wall which form a right triangle.

12. The drill and tap guide of claim 10, wherein said at least one step-shape profile is displaced from said bottom surface and is displaced from said recess along said edge.

13. The drill and tap guide of claim 10, wherein said at least one step-shape profile is recessed within each said edge.

14. The drill and tap guide of claim 1, wherein said positioning notch further includes undulation profiles along each said edge.

15. The drill and tap guide of claim 14, wherein said undulation profiles include a plurality of convex curves interspaced between a plurality of convex curves along each said edge, wherein said plurality of convex curves and said plurality of concave curves are connected by straight line segments.

16. The drill and tap guide of claim 14, wherein said undulation profiles extend between said bottom surface and said recess along said edge.

17. The drill and tap guide of claim 1, wherein said positioning notch further includes zig zag profiles along each said edge.

18. The drill and tap guide of claim 17, wherein said zig zag profiles are displaced from said bottom surface and are displaced from said recess along said edge.

19. The drill and tap guide of claim 17, wherein each said zig zag profile includes opposing walls which form a tip, such that said walls of each said zig zag profile form an obtuse angle.
